(19) United States
(12) Patent Application Publication
(10) Pub. No.: US 2008/0307985 A1
(43) Pub. Date: Dec. 18, 2008

(54) STENCIL PRINTING APPARATUS ALLOWING DOUBLE-SIDE PRINTING

(75) Inventor: Masakazu FUJITA, Miyagi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 12/041,264

(22) Filed: Mar. 3, 2008

(30) Foreign Application Priority Data
Jun. 12, 2007 (JP) 2007-155648

(51) Int. Cl. B41L 13/04

(52) U.S. Cl. 101/118

(57) ABSTRACT

A stencil printing apparatus allowing double-side printing able to suppress the drop in work efficiency caused by the occurrence of through-jam during a double-side printing operation, which includes: a printing portion having a plate cylinder and pressing means; a paper discharging portion, paper refeeding means for temporarily housing and then refeeding paper sheets on which an image has been formed on one side to the paper discharging portion; and switching means for guiding the paper sheets to either the paper discharging portion or paper refeeding means, and which performs a front-side printing step in which a front-side image is printed on one side of a paper sheet, and a rear-side printing step in which this paper sheet is fed to paper refeeding means, and refed from paper refeeding means to the printing portion, and then a rear-side image is printed on the other side of the paper sheet.

The stencil printing apparatus comprises control means for detecting that a printing operation failure has occurred, when a paper sheet, on which a front-side image has been printed, and which should be fed from the printing portion to paper refeeding means is fed to the paper discharging portion instead of being fed to paper refeeding means during double-side printing.

### BACKGROUND OF THE INVENTION

1. Field of the Invention

The present invention relates to a stencil printing apparatus which has paper refeeding means and which is able to carry out double-side printing.

2. Description of the Related Art

Digital-type thermosensitive stencil printing constitutes a known conventional and simple method of printing. This printing involves a thermal head comprising a plurality of very small heat-emitting elements being brought into contact with a master on which a thermoplastic resin and a porous support body are adhered and the master being conveyed by conveying means such as a platen roller while a pulse-like electrical current is imparted to the heat-emitting elements to produce a perforated plate in which a perforated image is thermally fused on the thermoplastic resin film of the master in accordance with image information, and then this perforated plate master being wound around a porous circular plate cylinder, ink supplied to the inner circumferential surface of the plate cylinder being squeezed out through apertures in the plate cylinder and the perforations in the master as a result of a paper sheet being pressed by pressure means such as a press roller against the outer circumferential surface of the plate cylinder, and this ink being transferred onto the paper sheet to produce a printed image on the paper sheet.

With the object of minimizing both the quantity of paper consumed and the document storage space and so on, the stencil printing described above has in recent years come to more often comprise double-side printing in which both sides of a paper sheet are printed. As an example thereof, Japanese Unexamined Patent Application No. 2005-246730 (U.S. patent Ser. No. 11/067,761) discloses a stencil printing apparatus in which a double-side printed material is produced in a single process as a result of the repeated implementation of an operation employing a divided plate master comprising a first platemaking image and a second platemaking image aligned with a shared edge in the direction of rotation of the plate cylinder, with a first of the platemaking images being printed on the front side of a first paper sheet supplied from a paper feeding portion and then this paper sheet being guided to paper feeding means, and the first of these platemaking images being printed on the front side of a second paper sheet supplied from the paper feeding portion and then this paper sheet being guided to paper feeding means, and the first paper sheet being refed from paper refeeding means and the other platemaking image being printed on the rear surface thereof and this paper sheet being discharged to a paper discharge tray.

While the paper sheet fed from the paper feeding portion is guided by paper refeeding means by a switching member subsequent to a front-side image being formed on the front side thereof at times of normal operation of the double-side printing operation of the stencil printing apparatus disclosed in this application, a so-called “through jam” problem in which, due to curvature of the paper sheet or for some other reason, the paper sheet on which a front-side image has been formed thereon is directly discharged by way of a paper discharging portion rather than being guided to paper refeeding means sometimes occurs.

Because of the concern associated with ordinary stencil printing apparatuses regarding the possibility of long term damage being done to the apparatus if a master jam or a paper sheet jam in which the master or the paper sheet becomes blocked in the interior of the apparatus occurs and the stencil printing apparatus continues to be operated in this state, these apparatuses are programmed to emergency stop when such jamming occurs. This is the same for when the above-described through-jam occurs.

In ordinary printing operations, an operator sets an original or a paper sheet in the stencil printing apparatus and the printing operation is automatically started as a result of print copy number being input and then a print start key pressed whereupon, subsequent to the input print copy number being reached, the stencil printing apparatus automatically stops. For large quantity printing of, for example, 1000 or more sheets, this allows the operator to leave the stencil printing apparatus during the printing operation to perform other tasks and, accordingly, affords better work efficiency. The operator returns to the stencil printing apparatus to collect the printed materials when they believe the printing operation has been completed.

However, if the jamming described above occurs during the printing operation, because the operation of stencil printing apparatus is caused to emergency stop at this point, an operator returning to the stencil printing apparatus at the time they believe the printing operation will be completed will find that the printing operation has not been completed and will be required to perform an appropriate dejamming operation before resetting the printing operation which, accordingly, causes a marked drop in work efficiency. While nothing can be done in terms of work efficiency when an emergency stop occurs due to jam such as the above-described paper sheet jam or master jam in which there is a fear of fatal damage being done to the apparatus, this drop in work efficiency can be suppressed by the operation of the stencil printing apparatus being continued if the jam is through-jam for which there is no fear of fatal damage being done to the apparatus.

In addition, if the operator remains in proximity of the stencil printing apparatus while carrying out the printing operation and the printing failure paper sheet can be immediately removed when through jam occurs, it is desirable in terms of simplifying the post processing following printing for the operation of the stencil printing apparatus to be stopped at the point when the through jam is detected.

Technologies relating to the present invention are also disclosed in, for example, Japanese Unexamined Patent Application Publication Nos. 2005-145027, 2005-144898 and 2003-200645 (U.S. Pat. No. 6,718,872)

### SUMMARY OF THE INVENTION

With a resolution to the problems described above in mind, it is an object of the present invention to provide a stencil printing apparatus in which the drop in work efficiency when through jam occurs during a double-side printing operation can be suppressed. What is claimed is:

In an aspect of the present invention, a stencil printing apparatus allows double-side printing. After performing a front-side printing step for printing a front-side image on one side of a paper sheet, a rear-side printing step for printing a rear-side image on the other side of the paper sheet is performed. The stencil printing apparatus comprises a printing portion having a plate cylinder and a pressing device provided separable from the plate cylinder; a paper discharging portion for discharging a paper sheet on which a printing has been performed in the printing portion; a paper refeeding device for temporarily housing and then refeeding a paper sheet, on which an image has been formed on one side thereof, in the printing portion to the printing portion; and a switching member for guiding a paper sheet that has passed through the printing portion to either the paper discharging portion or the refeeding device. The stencil printing apparatus further comprises a control device for detecting that a printing operation failure has occurred, during double-side printing, when a paper sheet on which a front-side image has been printed and which should be fed from the printing portion to the paper refeeding device is not fed to the paper refeeding device and is instead fed to the paper discharging portion.

### BRIEF DESCRIPTION OF THE DRAWINGS

The above and other objects, features and advantages of the present invention will become more apparent from the following detailed description taken with the accompanying drawings in which:

FIG. 1 is a front view schematically showing a double-side printing stencil printing apparatus serving as a first embodiment of the present invention is adopted;

FIG. 2 is a diagram schematically showing an operating panel employed in this stencil printing apparatus;

FIG. 3 is a block diagram schematically showing control means employed in this stencil printing apparatus;

FIG. 4 is a diagram for explaining a normal double-side printing operation carried out by this stencil printing apparatus;

FIG. 5 is a diagram for explaining a printing operation failure in this stencil printing apparatus;

FIG. 6 is a flow chart of a double-side printing operation executed during a first mode of this embodiment;

FIG. 7 is a flow chart of a double-side printing operation executed during a second mode of this embodiment;

FIG. 8 is a flow chart of a double-side printing operation carried out by a modification of this embodiment; and

FIG. 9 is a flow chart of a double-side printing operation carried out by another modification of this embodiment.

### DESCRIPTION OF THE PREFERRED EMBODIMENTS

An embodiment of the present invention will be hereinafter described in detail with reference to the drawings.

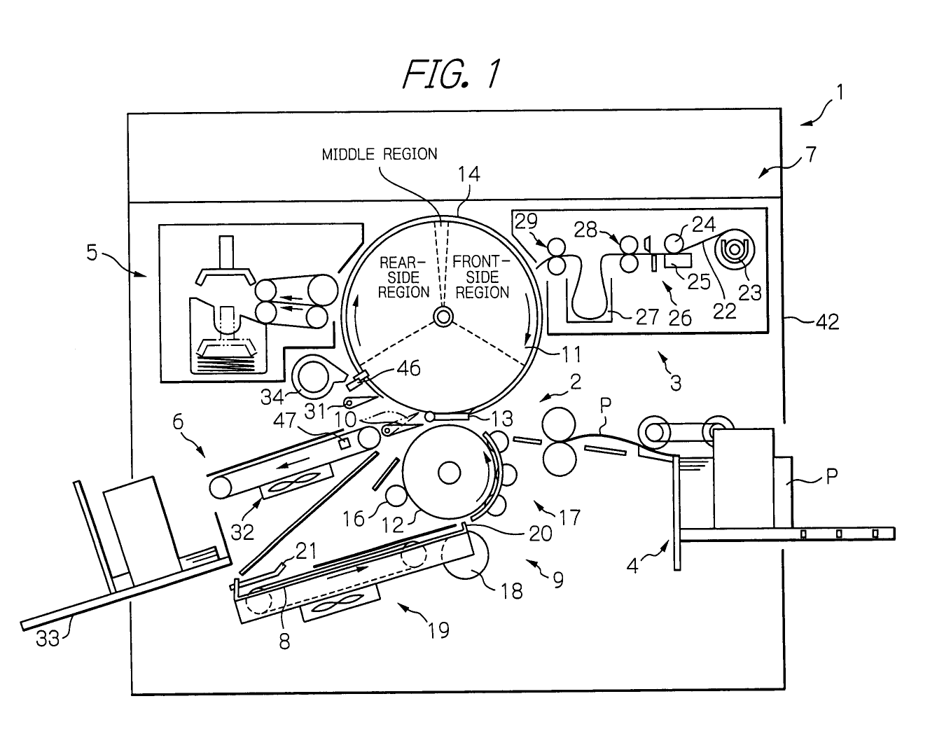

FIG. 1 shows a stencil printing apparatus serving as an embodiment thereof. The configuration of this stencil printing apparatus relates to the double-side printing apparatus disclosed in the above-noted Japanese Unexamined Patent Application Publication No. 2003-200645 and, accordingly, a description of these elements has as far as possible been omitted.

A stencil printing apparatus 1 of FIG. 1 includes a printing portion 2, a platemaking portion 3, a paper feeding portion 4, a plate discharging portion 5, a paper discharging portion 6, an image reading portion 7, paper refeeding means 9 having an auxiliary tray 8, and a switching member 10.

The printing portion 2 is arranged in the approximate center of an apparatus main body 42 and comprises a plate cylinder 11 and a press roller 12 serving as pressing means. The plate cylinder 11 is rotatably supported in the apparatus main body 42 and rotationally driven by plate cylinder drive means not shown in the diagram. The plate cylinder 11 comprises a closable clamp 13 in its outer circumferential surface, a divided plate master 14 made by the platemaking portion 3 being wound around the outer circumferential surface of the plate cylinder 11 during the double-side printing operation. A first platemaking image correspondent to a front-side image and a second platemaking image correspondent to a rear-side image are formed in the divided plate master 14, and non-platemaking sections are formed between these platemaking images. The divided plate master 14 is wound around the plate cylinder 11 so that the first platemaking image corresponds to the front-side region, the second platemaking image to the rear surface region thereof, and the non-platemaking image section to the middle region thereof as shown in FIG. 1. A rotary encoder 46 for detecting the position of the plate cylinder 11 is provided in proximity of the outer circumferential surface of the plate cylinder 11. The rotary encoder 46 outputs a plate cylinder position detection signal to a later-described control means 30.

A press roller 12 is disposed below the plate cylinder 11. The two ends of the press roller 12, which is constituted from a water-repellent elastic body such as a fluoride resin, are rotatably supported by oscillation means not shown in the diagram. The press roller 12 is selected to occupy either a position as shown in FIG. 1 in which the outer circumferential surface thereof is separate from the plate cylinder 11, or a pressure-contacting position in which the outer circumferential surface pressure-contacts the divided plate master 14 on the plate cylinder 11. A cleaning roller 16 that cleans circumferential surface of the press roller 12 as a result of contact therewith is disposed in proximity of the circumferential surface of the press roller 12. The cleaning roller 16 is rotationally driven by drive means not shown in the diagram.

A paper refeed guiding member 17 for conveying front-side-printed paper sheets P fed from paper refeeding means 9 along the circumferential surface of the press roller 12 is disposed in proximity of the press roller 12 to the upper left thereof, and a paper refeed resist roller 18 for feeding out paper sheets P held in the auxiliary tray 8 as a result of being brought into contact with the circumferential surface of the press roller 12 is disposed below the press roller 12. A paper refeed conveying unit 19 comprising the auxiliary tray 8 in the front side is disposed to the below left of the press roller 12, a paper refeed positioning member 20 being integrally provided therein. A paper sheet receiving panel 21 movable along the front side of the auxiliary tray 8 is disposed above the paper refeed conveying unit 19. Paper refeeding means 9 is constituted from the auxiliary tray 8, the paper refeed guiding member 17, the paper refeed resist roller 18, the paper refeed positioning member 20, the paper refeed conveying unit 19 and the paper sheet receiving panel 21.

The switching member 10 is disposed on the path along which the paper sheets P are conveyed to the left of the position where the plate cylinder 11 and press roller 12 come into contact. The switching member 10 of which the end portion thereof in the downstream side in the direction of conveyance of the paper sheets is turnably supported by the apparatus main body 42 and which is moved by moving means not shown in the diagrams selectively occupies a first position shown by the solid line and a second position shown by a dotted line in FIG. 1. The paper sheets P that pass between the plate cylinder 11 and the press roller 12 are guided to the paper discharging portion 6 when the switching member 10 occupies the first position, and are guided to the auxiliary tray 8 when the switching member 10 occupies the second position.

The platemaking portion 3 is disposed to the above right of the printing portion 2. The platemaking portion 3 has a well-known configuration that includes a master holding portion 23 for holding a master roll formed from a master 22 wound in a roll shape, a platen roller 24, a thermal head 25, master cutting means 26, a master stock portion 27, a tension roller pair 28 and an inversion roller pair 29, the divided plate master 14 being produced by this platemaking portion 3.

The paper feeding portion 4 is disposed below the platemaking portion 3. The paper feeding portion 4 has a well-known configuration that includes a paper feed tray, a paper feed roller, a separation roller, a separation pad, and a resist roller pair.

The plate discharging portion 5 disposed to the above left of the printing portion 2 also has a well-known configuration that includes an upper plate discharging member, a lower plate discharging member, a plate discharge box and a compression plate, used divided plate masters 14 being separated from the outer circumferential surface of the plate cylinder 11 and discarded to the interior of the plate discharge box.

The paper discharging portion 6 is disposed below the plate discharging portion 5. The paper discharging portion 6 includes a peeling claw 31, a paper discharge conveyance unit 32, a paper discharge tray 33, and a peel fan 34. The tip-end portion of the peeling claw 31 is separatably provided with respect to the outer circumferential surface of the plate cylinder 11 by oscillation means not shown in the diagrams, the paper sheets P being peeled from the outer circumferential surface of the plate cylinder 11 when the approached position is occupied thereby. The paper discharge conveyance unit 32 includes a drive roller, a driven roller, a continuous belt and a suction fan and is conveyed in the direction of the arrow of FIG. 1 while the printed paper sheets P are being suctioned onto the upper surface of the continuous belt. The paper discharge tray 33 comprises one end fence and a pair of side fences, the printed paper sheets P being stacked on the upper surface thereof. The peel fan 34 is disposed above the peeling claw 31, the leading edge of each of the paper sheets P peeled from the outer circumferential surface of the plate cylinder 11 by the switching member 10 subsequent to completion of a front-side printing step and the paper sheets P peeled from the outer circumferential surface of the plate cylinder 11 by the peeling claw 31 subsequent to completion of a rear-side printing step being lifted up by air blown therefrom toward the outer circumferential surface of the plate cylinder 11.

A paper sheet detection sensor 47 for detecting when a paper sheet P has been conveyed toward the paper discharge conveyance unit 32 is disposed below the plane along which the continuous belt is conveyed in a position on the upstream side in the direction of conveyance of the paper sheet in the interior of the paper discharge conveyance unit 32. Upon detecting a paper sheet P, the paper sheet detection sensor 47 outputs a paper sheet detection signal to later-described control means 30.

The image reading portion 7 is disposed in the upper portion of the apparatus main body. The image reading portion 7 comprises a contact glass not shown in the diagram, a pressing panel not shown in the diagram separatably provided with respect to the contact glass, a reflection mirror and fluorescent light of which neither are shown in the diagram for scanning and reading an original image, a lens not shown in the diagram for converging the scanned image, and an image sensor not shown in the diagram for processing the converged image.

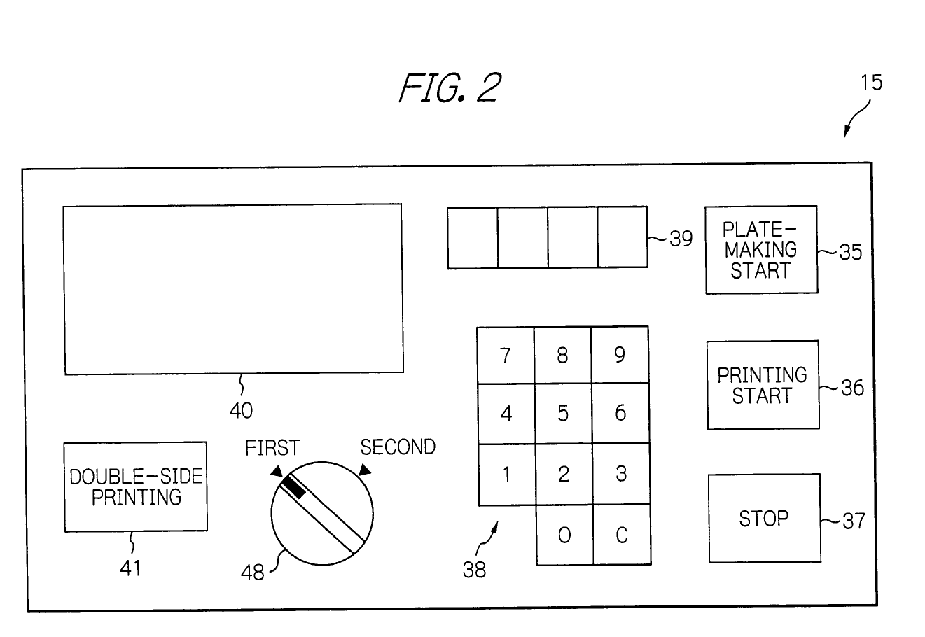

FIG. 2 shows an operating panel of the stencil printing apparatus 1. In addition to a well-known configuration that includes a platemaking start key 35, a printing start key 36, a stop key 37, a ten key 38, a display device 39 constituted from a 7-segment LED, a display device 40 constituted from an LCD and a double-side printing key 41 pressed down when double-side printing is performed, a switching switch 48 serving as switching means for switching the operation of the stencil printing apparatus 1 when the paper sheets P that should be fed to paper refeeding means 9 during double-side printing are not fed to the paper refeeding means 9 but instead are fed to the paper discharging portion 6 is disposed in the operating panel 15.

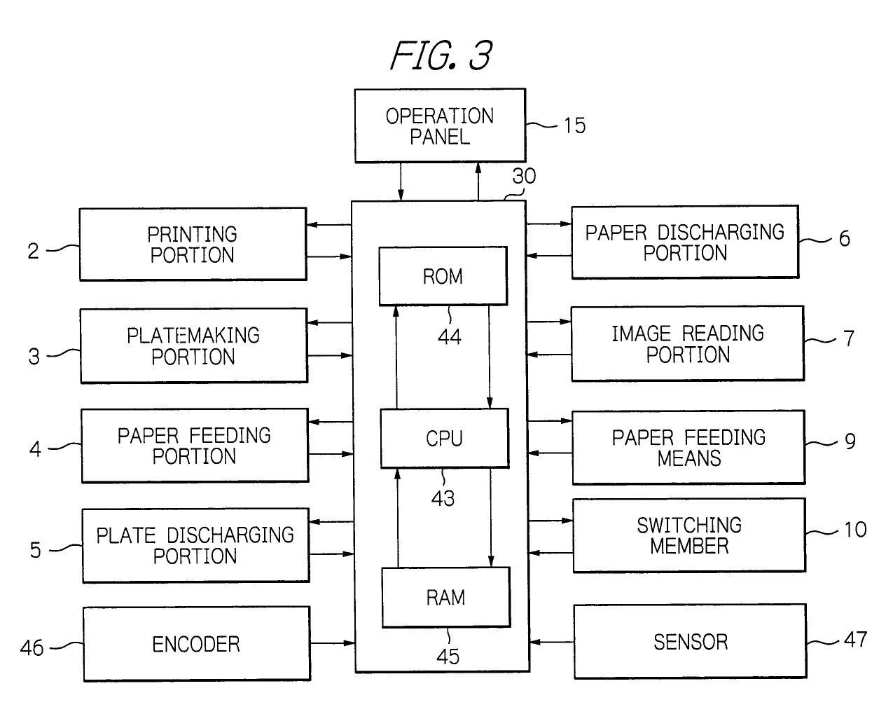

FIG. 3 is a block diagram of control means employed in the stencil printing apparatus 1. In the diagram, control means 30 constitutes a microcomputer comprising in its interior a CPU 43, ROM 44 and RAM 45 for controlling the operation of each of the printing portion 2, platemaking portion 3, paper feeding portion 4, plate discharging portion 5, paper discharging portion 6, image reading portion 7, paper refeeding means 9 and the switching member 10 in accordance with a plate cylinder position detection signal from the rotary encoder 46, operation signal from the operating panel 15, and paper sheet detection signal from the paper sheet detection sensor 47. An operation program for the stencil printing apparatus 1 is stored in the ROM 44 and various numerical values and information and so on are temporarily stored in the RAM 45, the CPU 43 executing an operation control of the stencil printing apparatus 1 in accordance with the operation program read from the ROM 44 and the numerical values and information and so on stored in the RAM 45.

A single-side print standby state of the stencil printing apparatus 1 described above is established as a result of actuation of the plate discharging portion 5 to perform a plate discharging operation and then actuation of the platemaking portion 3 to perform a platemaking operation subsequent to an original being set in the image reading portion 7 and the platemaking start key 35 being pushed, and the master plate produced thereby being wound around the plate cylinder 11. Thereafter, paper sheets P are continuously fed from the paper feeding portion 4 and a single-side printing operation performed thereon subsequent to a print copy number being entered and the printing start key 36 being pushed. The single-side printing operation is completed and the single-side print standby state of the stencil printing apparatus 1 re-established subsequent to the entered print copy number having been reached.

In addition, a double-side print standby state is established as a result of the actuation of the plate discharging portion 5 to perform a plate discharging operation and then actuation of the platemaking portion 3 to perform a platemaking operation subsequent to an original being set in the image reading portion 7 and the double-side printing key 41 being pushed, and then the platemaking start key 35 being pushed, and the divided plate master 14 being wound around the plate cylinder 11. Thereafter, paper sheets P are continuously fed from the paper feeding portion 4 and a double-side printing operation performed thereon subsequent to a print copy number being entered and the printing start key 36 being pushed. The double-side printing operation will be hereinafter described.

The paper sheets P are pressure-contacted against the first platemaking image of the divided plate master 14 on the plate cylinder 11 as a result of the press roller 12 occupying the pressure-contact position when the plate cylinder 11 is rotated a predetermined angle so that the front-side region thereof occupies a predetermined position correspondent to the press roller 12, and a front-side image is transferred onto one side thereof. The paper sheets P on which the front-side printing has been completed are peeled from the outer circumferential surface of the plate cylinder 11 by the tip end of the switching member 10 occupying the second position and fed to the paper refeed conveying unit 19. At this time, the leading edge of the paper sheets P is received by the paper sheet receiving panel 21 which are then stacked from the trailing edge side thereof onto the auxiliary tray 8. The paper sheets P on the auxiliary tray 8 are conveyed in the direction of the arrow of FIG. 1 by the paper refeed conveying unit 19, and are temporarily stopped in a state in which the leading edge thereof abuts the paper refeed positioning member 20.

The rotation of the plate cylinder 11 is continued while a first paper sheet P is being guided onto the auxiliary tray 8, and a second paper sheet P is fed from the paper feeding portion 4 at the same timing as the first paper sheet P. In the same way as for the first paper sheet P, a front-side image is transferred by the press roller 12 onto one side of the second paper sheet P which is then fed to the paper refeed conveying unit 19 by the switching member 10 that occupies the second position. After the second paper sheet P has been fed from the paper feeding portion 4, the paper refeed resist roller 18 is actuated at a timing slightly faster than for the rear surface region of the plate cylinder 11 to arrive at a position correspondent to the press roller 12, and the first paper sheet P held in the auxiliary tray 8 is press-contacted against the circumferential surface of the press roller 12. The first paper sheet P press-contacting the circumferential surface of the press roller 12 is conveyed by the rotational force of the press roller 12 which is driven-rotated as a result of pressure-contacting the plate cylinder 11 toward a region where it abuts the plate cylinder 11 whereupon, as a result of being pressingly-contacted against the second platemaking image of the divided plate master 14, a rear-side image is transferred onto the other side thereof.

The first paper sheet P onto which a rear-side image has been transferred to complete the double-side printing is guided to the paper discharging portion 6 by the switching member 10 occupying the first position and, as a result of air being blown thereon from the peel fan 34, the leading edge portion thereof is lifted up and separated from the circumferential surface of the plate cylinder 11 by the tip end of the peeling claw 31. The separated printed paper sheet P is fed to the paper discharge conveyance unit 32, and then conveyed and stackably discharged to the paper discharge tray 33. The above-described operation is repeated until the set number of print copies is reached and, when the double side printing operation on the set number of copies is completed, the operation of each part is stopped to re-establish the double-side print standby state of the stencil printing apparatus 1.

In the double-side printing operation as described above, while a front-side image is transferred by the press roller 12 onto one side of the second paper sheet P fed from the paper feeding portion 4 which is then fed to the paper refeed conveying unit 19 by the switching member 10 occupying the second position, and the paper refeed resist roller 18 is actuated so that the first paper sheet P held in the auxiliary tray 8 pressingly-contacts the circumferential surface of the press roller 12, as is described above in the section pertaining to the problems resolved by the present invention, a so-called “through jam” problem in which, due to curvature of the paper sheet or for some other reason, the paper sheet P on which a front-side image has been formed thereon is directly discharged by way of the paper discharging 6 portion rather than being guided to paper refeeding means 9 sometimes occurs. With a resolution to this problem in mind, in the configuration of the present invention the control means 30 executes an operation control of the stencil printing apparatus 1 in accordance with a plate cylinder position detection signal from the rotary encoder 46 and a paper sheet detection signal from the paper sheet detection sensor 47. The operation control of the stencil printing apparatus 1 executed by the control means 30 will be hereinafter described.

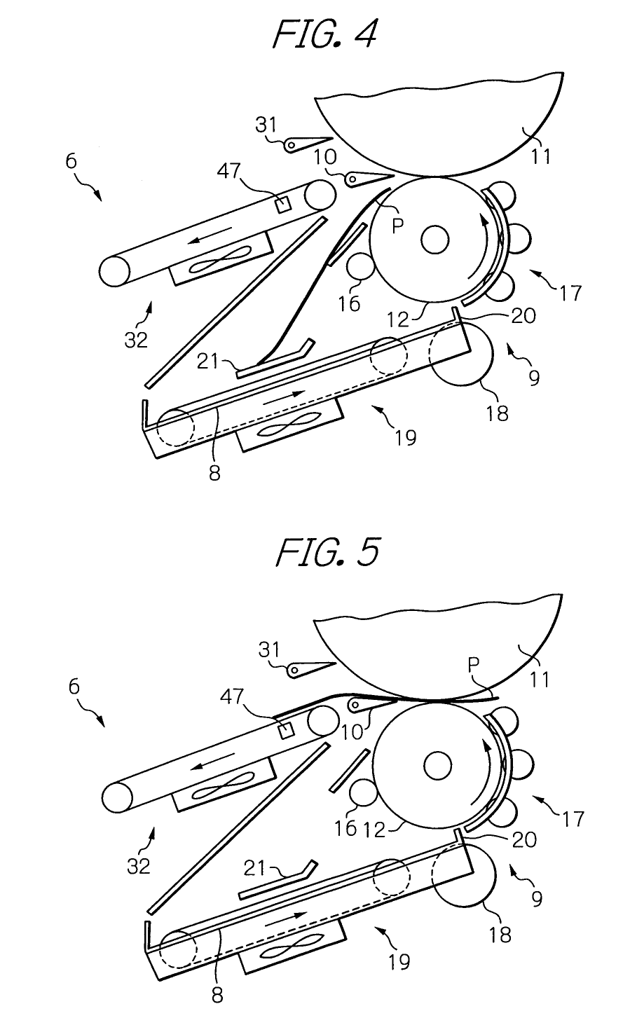

Because the pulse number of the rotary encoder 46 correspondent to a position at which the single-side printed paper sheets P onto which a front-side image has been transferred are fed by paper refeeding means 9 is pre-stored as a predetermined value in the ROM 44 and because there is no detection signal output from the paper sheet detection sensor 47 if a normal double-side printing operation is to be carried out at the timing at which the single-side printed paper sheets P are fed by paper refeeding means, when there is no detection signal output from the paper sheet detection sensor 47 when the pulse number of the rotary encoder 46 is a predetermined value, the control means 30 judges the front-side printed paper sheets P as having been guided normally to paper refeeding means 9 by the switching member 10 as shown in FIG. 4 and, as a result, continues the double-side printing operation. However, when a detection signal is output from the paper sheet detection sensor 47 when the pulse number of the rotary encoder 46 is a predetermined value, the control means 30 detects the occurrence of a printing operation failure judging the front-side printed paper sheets P as not having being guided by the switching member 10 but instead as having been guided to the paper discharging portion 6 as shown in FIG. 5.

According to the configuration described above, because single-side printed paper sheets P guided to the paper refeeding means 9 rather than being fed to the paper discharging portion 6 in a double-side printing operation can be detected by the control means 30 as a printing operation failure, an operator can be made aware that a printing failure has occurred and, in turn, can perform an action to deal with this printing failure.

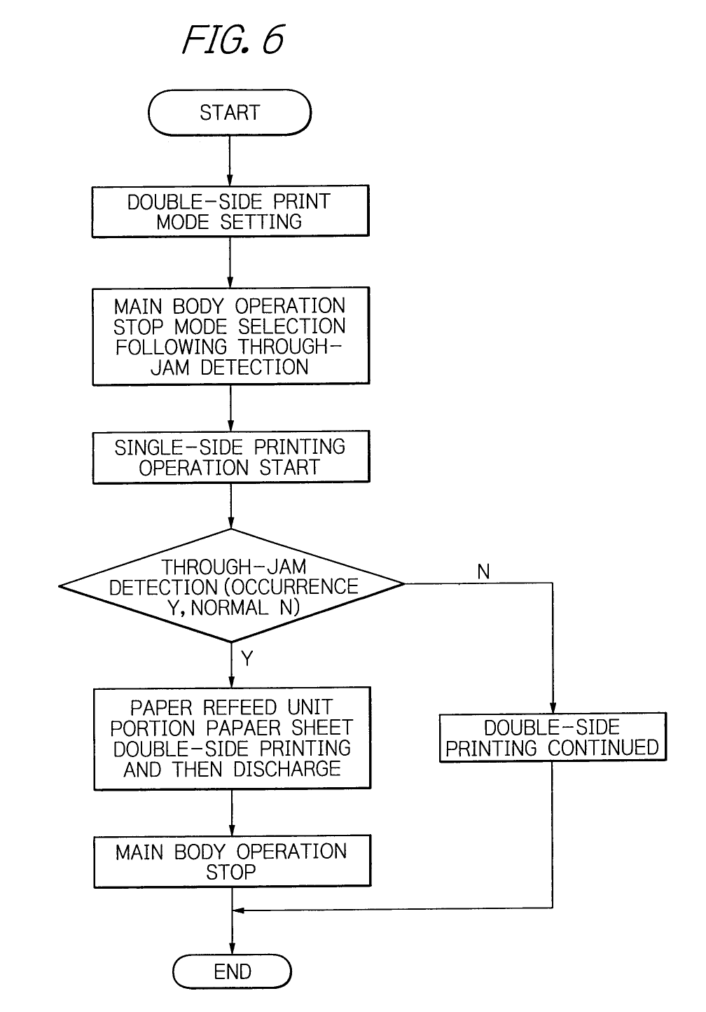

In the configuration described above, if the switching switch 48 is switched to the “first” side prior to the double-side printing operation, the control means 30 refeeds to the print portion 2 a paper sheet P preceding the paper sheet P for which the printing operation failure was detected, that is to say, the paper sheet P held in paper refeeding means 9 when the paper sheet P in question on which a printing operation on the front side thereof has been completed is not guided to paper refeeding means 9 but is instead guided to the paper discharging portion 6, stops paper feed from the paper feeding portion 4 after a rear-side image has been transferred onto this paper sheet P, and then stops the operation of the stencil printing apparatus 1 after the paper sheet P has been discharged to the paper discharging portion 6. FIG. 6 illustrates this series of operations.

Based on this “first” operation control, because an operator can be made immediately aware of the occurrence of printing failure and, moreover, can be made immediately aware of the printing failure of the second paper sheet P from the top of the paper sheets P discharged to the paper discharge tray 33 of the paper discharging portion 6, dealing with this printing failure is made simpler.

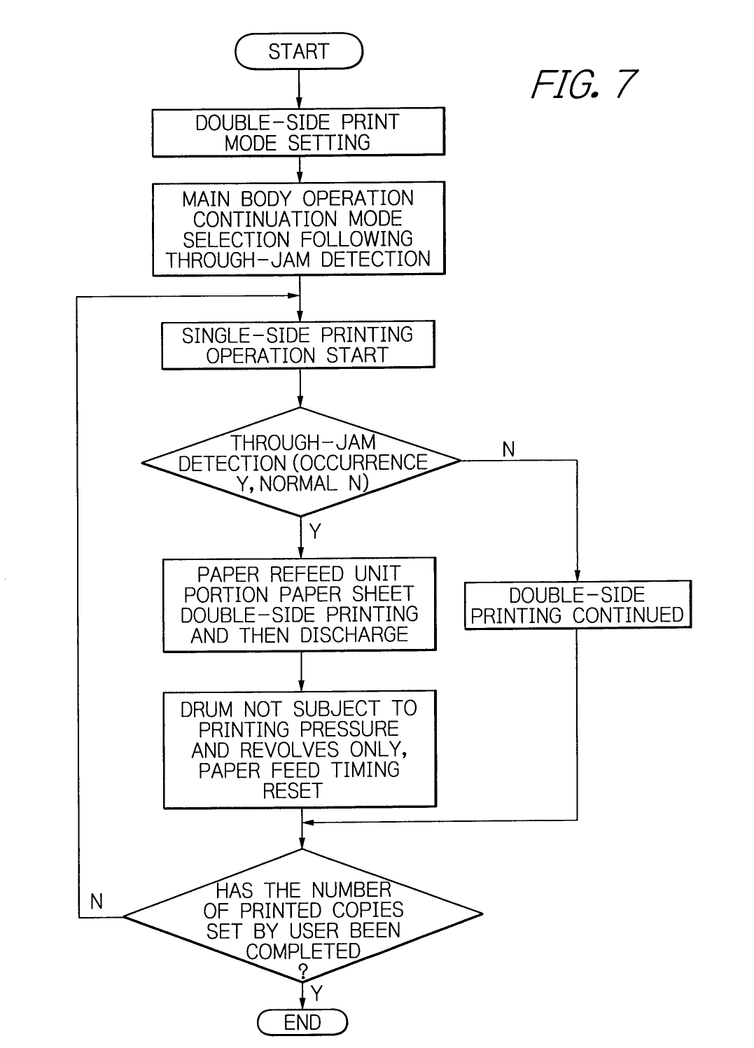

In the configuration described above, if the switching switch 48 is switched to the “second” side prior to the double-side printing operation, the control means 30 refeeds to the print portion 2 a paper sheet P preceding the paper sheet P for which the printing operation failure was detected, that is to say, the paper sheet P held in paper refeeding means 9 when the paper sheet P in question on which a printing operation on the front side thereof has been completed is not guided to paper refeeding means 9 but is instead guided to the paper discharging portion 6, does not cause the press roller 12 to pressure-contact the plate cylinder 11 after a rear-side image has been transferred onto this paper sheet P but instead allows the plate cylinder 11 to revolve idly and, after the paper sheet P has been fed to the paper discharging portion 6, restarts the paper feed from the paper feeding portion 4 when the plate cylinder 11 reaches the position of paper feed from the aaa 4 in accordance with a plate cylinder position signal from the rotary encoder 46 to continue the double-side printing operation. FIG. 7 illustrates this series of operations.

According to this “second” operation control, because the double-side printing operation is continued without the stencil printing apparatus 1 being stopped when a printing failure for which there is no fear of damage being done to the apparatus occurs, the generation of the problem of a marked drop in work efficiency caused by emergency stop of the stencil printing apparatus and the operator returning to the stencil printing apparatus at the time they believe the printing operation will be completed and finding that the printing operation has not been completed can be prevented and, in turn, a drop in work efficiency can be prevented.

According to the above-described configuration, because a simple switching between a “first” operation control and a “second” operation control can be performed, selection of, for example, the “first” operation control when the operator remains in proximity of the stencil printing apparatus 1 while the printing operation is carried out and the “second” operation control when the operator leaves the stencil printing apparatus 1 while the printing operation is carried out is possible and, as a result, the work efficiency of both can be improved and, in addition, the usability thereof that allows selection of a double-side printing operation correspondent to the usage conditions of the operator can be markedly improved.

A configuration of the abovementioned embodiment in which, when the “second” operation control is selected, the number of the sheet at which a printing operation failure has occurred during a printing operation is stored by the control means 30 in the RAM 45, and all stored details subsequent to the completion of the double-side printing operation are displayed in the display device 40 may be adopted. In this case, the RAM 45 functions as storage means and the display device 40 functions as display means. According to this configuration, the number of the paper sheet P stacked on the paper discharge tray 33 on which a printing failure has occurred can be discriminated and, accordingly, dealing with this printing failure is made simpler.

A configuration of the abovementioned embodiment in which selection means for selecting a specific paper sheet P discharged to the paper discharge tray 33 from other paper sheets P is employed and, when the “second” operation control is selected and the control means 30 has detected a printing operation failure, selection means selects the paper sheet P on which a printing failure has occurred from other paper sheets P may also be adopted. Examples of selection means include a tape cutter device for affixing tape to a specified paper sheet P, or a device for displacing a specified paper sheet P alone from other paper sheets P. According to this configuration, because the paper sheet P on which a printing failure has occurred can be immediately selected from among the paper sheets P stacked on the paper discharge tray 33, dealing with this printing failure is made even simpler.

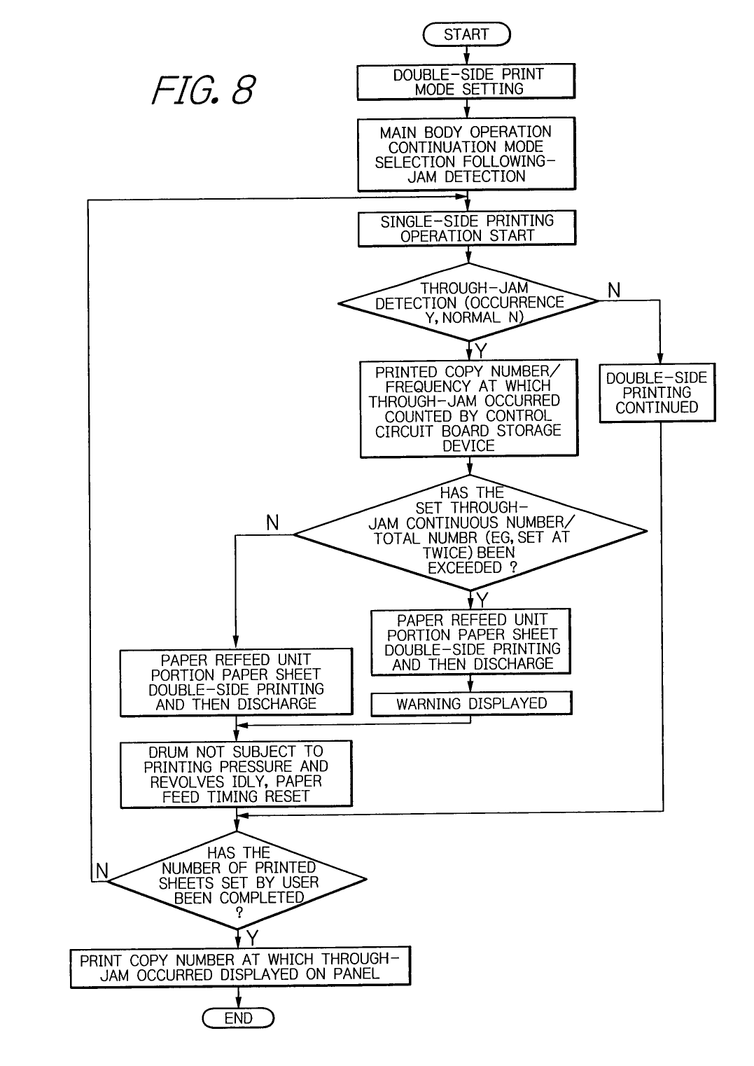

A configuration of the abovementioned embodiment in which, when the “second” operation control is selected, the number of the sheet at which a printing operation failure has occurred during a printing operation, how many continuous number of sheets a printing operation failure has occurred, and how many times in total a printing operation failure has occurred is stored by the control means 30 in the RAM 45, and in which a warning is issued to the display device 40 when a printing operation failure has occurred continuously a predetermined number of times or a printing operation failure has occurred in total a predetermined number of times, and in which all stored details following the completion of the double-side printing operation are displayed in the display device 40 may be adopted. In this case, while the RAM 45 functions as storage means and the display device 40 functions as warning means, warning means that issues a noise warning or the like to the operator may be adopted. FIG. 8 illustrates this operation. According to this configuration, because a warning is issued by warning means when a serious failure such as when a printing operation failure has occurred continuously a predetermined number of times or a printing operation failure has occurred in total a predetermined number of times, alteration to the printing conditions and maintenance and so on of the apparatus can be accelerated and drastic action taken for dealing with the printing failure.

The configuration described above may be configured so that a mode for altering the predetermined number of the continuous number of times or total number of times of printing operation failure is started as a result of, for example, a specific key of the operating panel 15 being pushed, and so that these predetermined numbers are alterable using the key pad 38. In addition, while the abovementioned configuration is configured so that a double-side printing operation is continuously carried out even when a printing operation failure has occurred continuously a predetermined number of times or a printing operation failure has occurred a predetermined total number of times, it may be configured so that the apparatus is stopped in these cases.

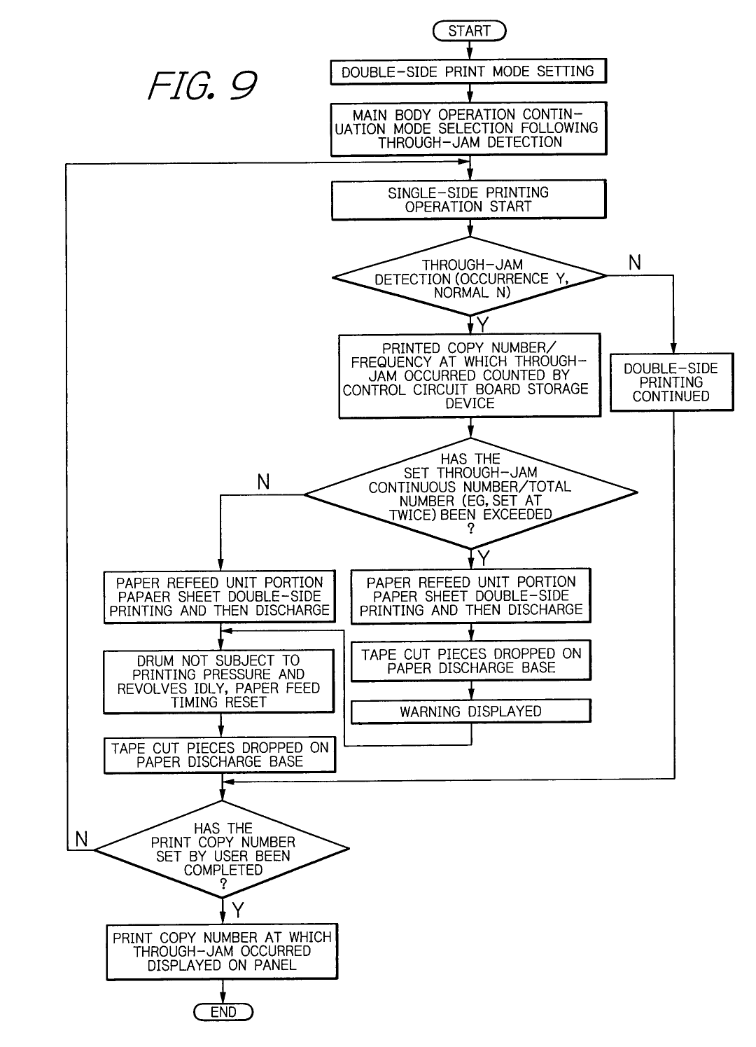

Furthermore, a configuration in which the above-described selection means is additional provided in the configuration described above in which a warning is issued to the display device 40 when the printing operation failure has occurred continuously a predetermined number of times or a printing operation failure has occurred a predetermined total number of times and all details following the completion of the double-side printing operation are displayed in the display device 40 may be adopted. FIG. 9 shows the operation in this case. According to this configuration, because alteration to the printing conditions and the maintenance and so on of the apparatus by the operator can be accelerated, and because the paper sheet P on which a printing failure has occurred can be selected from the paper sheets P stacked on the paper discharge tray 33 can be immediately selected, the usability of the stencil printing apparatus 1 is markedly improved.

According to the present invention, because a printing operation failure can be detected as having occurred during double-side printing when a single-side printed paper sheet is not fed to paper refeeding means and is instead fed to the paper discharging portion, an operator can be made aware that a printing failure has occurred and, in turn, can perform an action to deal with this printing failure.

Various modifications will become possible for those skilled in the art after receiving the teachings of the present disclosure without departing form the scope thereof.

What is claimed is:

1. A stencil printing apparatus allowing double-side printing, in which, after performing a front-side printing step for printing a front-side image on one side of a paper sheet, a rear-side printing step for printing a rear-side image on the other side of the paper sheet is performed,
the stencil printing apparatus, comprising:
a printing portion having a plate cylinder and pressing means provided separable from said plate cylinder;
a paper discharging portion for discharging a paper sheet on which a printing has been performed in said printing portion;
paper refeeding means for temporarily housing and then refeeding a paper sheet, on which an image has been formed on one side thereof, in said printing portion to said printing portion; and
a switching member for guiding a paper sheet that has passed through said printing portion to either said paper discharging portion or said refeeding means,
the stencil printing apparatus, further comprising:
control means for detecting that a printing operation failure has occurred, during double-side printing, when a paper sheet on which a front-side image has been printed and which should be fed from said printing portion to said paper refeeding means is not fed to said paper refeeding means and is instead fed to said paper discharging portion.

2. The stencil printing apparatus as claimed in claim 1, further comprising switching means for switching between a first mode for stopping a double-side printing operation and a second mode for continuing a double-side printing operation, when a printing operation failure has been detected by said control means.

3. The stencil printing apparatus as claimed in claim 2, wherein, when the first mode has been selected by said switching means and a printing operation failure has been detected by said control means, the double-side printing operation is stopped following completion of the double-side printing operation on a paper sheet preceding the paper sheet that has triggered the printing operation failure.

4. The stencil printing apparatus as claimed in claim 2, wherein, when the second mode has been selected by said switching means and a printing operation failure has been detected by said control means, the double-side printing operation is continued, following completion of a double-side printing operation on a paper sheet preceding the paper sheet that has triggered the printing operation failure, with said plate cylinder revolving idly while not causing said pressing means to contact with said plate cylinder, and following a timing correction.

5. The stencil printing apparatus as claimed in claim 4, further comprising:
storage means for storing which paper sheet a printing operation failure has occurred to during the printing operation; and
display means for displaying details stored in said storage means, wherein
said display means performs a display following completion of double-side printing on a set number of paper sheets if the second mode has been selected by said switching means and a printing operation failure has been detected by said control means.

6. The stencil printing apparatus as claimed in claim 4, further comprising selection means for selecting a specific paper sheet discharged to said paper discharging portion from other paper sheets, wherein
said selection means selects a paper sheet to which a printing operation failure has occurred from other paper sheets if the second mode has been selected by said switching means and a printing operation failure has been detected by said control means.

7. The stencil printing apparatus as claimed in claim 4, further comprising warning means for issuing a warning, wherein
said warning means issues a warning if the second mode is selected by said switching means and a printing operation failure for the predetermined consecutive number of times or a predetermined number of times by said control means.

8. The stencil printing apparatus as claimed in claim 7, wherein the predetermined consecutive number of times or predetermined total number of times, about which said warning means issues a warning, can be set.
